(19) United States
(12) Patent Application Publication
(10) Pub. No.: US 2008/0142314 A1
(43) Pub. Date: Jun. 19, 2008

(54) Methods and apparatus to connect a brake disc to a brake

(76) Inventors: Anthony Scelsi, Elkhart, IN (US); Esaw Harris, South Bend, IN (US); Jonathan T. Beehler, Bremen, IN (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/638,854

(22) Filed: Dec. 14, 2006

(51) Int. Cl. F16D 55/22

(52) U.S. Cl. 188/73.1

(57) ABSTRACT

Methods and apparatus to connect a brake disc to a brake are disclosed. A brake disc torque pad is received in a complementary shaped opening in the brake disc and the torque pad engages a tab of the brake to connect the brake disc to the brake.

### FIELD OF THE DISCLOSURE

This disclosure relates generally to methods and apparatus to connect a brake disc to a brake, and more particularly to a brake disc torque pad that engages a tab of a brake to connect the torque pad and brake disc to the brake.

### BACKGROUND

The use of carbon-carbon composite brake discs in aircraft brakes, which also have been referred to in the art as carbon brakes, is well-known in the aerospace industry. Carbon-carbon composite brake discs are manufactured by aircraft wheel and brake manufacturers using a variety of manufacturing methods. These methods generally require lengthy fabrication and densification methods. In recent years, aircraft manufacturers have increasingly specified the use of such carbon-carbon composite brake discs for brakes designed for use with new aircraft models. Typically, the backing plate disc of a carbon brake is attached to the adjacent backing plate of the torque tube to prevent rotational or axial movement of the backing plate disc. Numerous torque pad structures and related parts have been used to connect the torque pads to the backing plate.

### BRIEF DESCRIPTION OF THE DRAWINGS

FIG. 1 is a partial cut-away illustration of a known aircraft carbon brake showing the torque pad attachment to the carbon brake and the torque pad engagement with a carbon-carbon composite backing plate disc.

FIG. 2 is another partial cut-away illustration of the known aircraft carbon brake of FIG. 1 showing the attachment of the carbon-carbon composite backing plate disc to the brake.

FIG. 3 is a partial cut-away illustration of an example carbon brake showing the attachment of an example torque pad to both the example carbon brake and the carbon-carbon composite backing plate disc.

FIG. 4 is a cut-away illustration of the example torque pad.

FIG. 5 is a perspective illustration of the example torque pad.

FIG. 6 is another perspective illustration of the example torque pad.

FIG. 7 is a partial cut-away perspective illustration of the example carbon brake showing the attachment of the example torque pad to both the example carbon brake and the carbon-carbon composite backing plate disc.

FIGS. 8A-C are schematic illustrations of the mounting of the example torque pad to the example carbon brake.

FIG. 9 is a flow diagram representative of an example method to couple a carbon-carbon composite braking plate disc to the backing plate of an example carbon brake.

### DETAILED DESCRIPTION

In general, example methods and apparatus disclosed herein to connect a brake disc to a brake may be applied to brakes that are manufactured from various materials and/or by various manufacturing methods. Additionally, while the examples described herein are described in connection with aircraft braking applications in the aerospace industry, the teachings of this disclosure may also be applicable to a variety of braking applications for different vehicles and/or mechanisms in different industries.

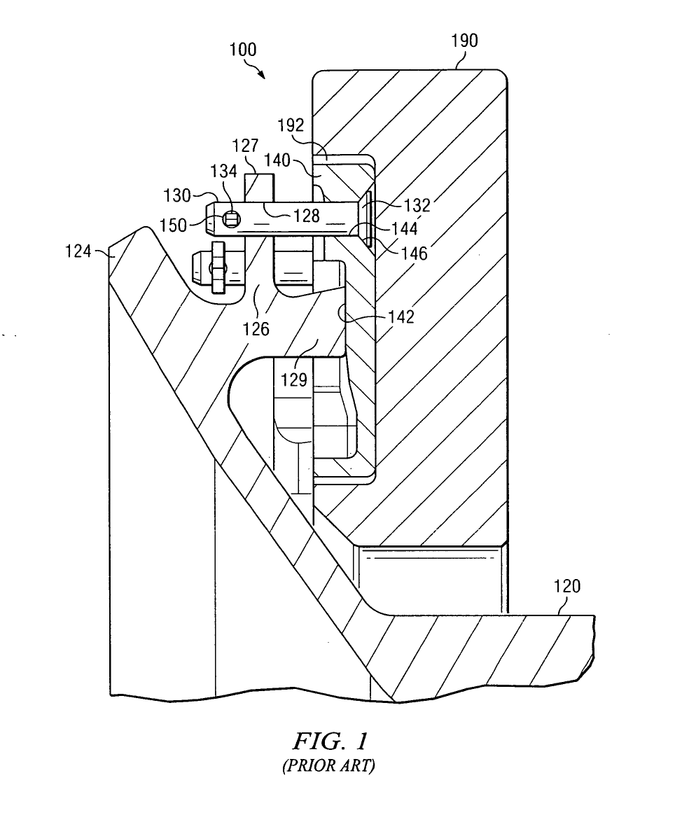

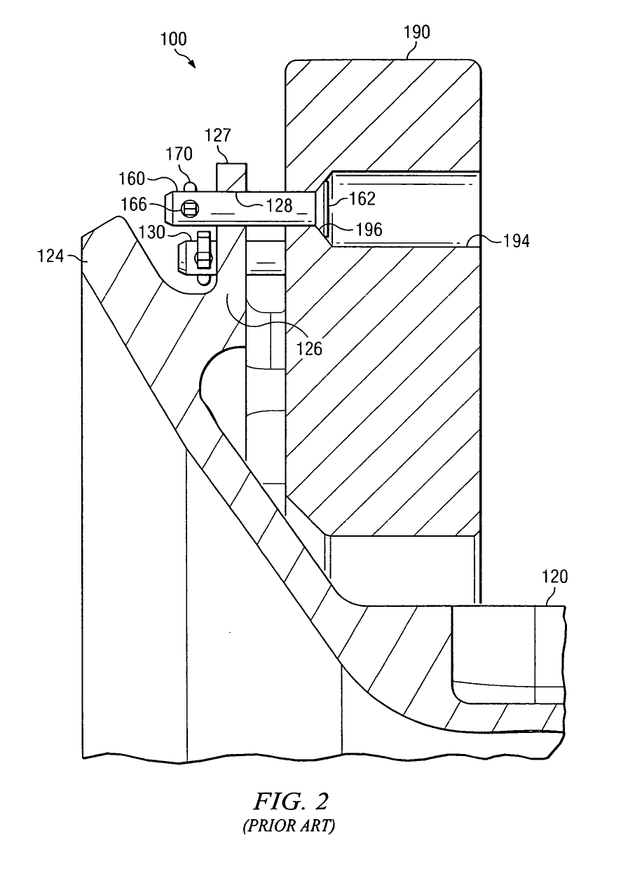

FIG. 1 is a partial cut-away view of a known aircraft carbon brake 100. The carbon brake 100 includes a torque tube 120 that extends axially from a piston housing (not shown) to a backing plate 124. Located about the torque tube 120 is a plurality of interleaved stator and rotor discs (not shown) of which only a carbon-carbon composite backing plate disc 190 is illustrated. The backing plate 124 includes a plurality of circumferentially spaced-apart tabs 126. The tabs 126 each include a radially extending tang 127 having a through opening 128 and an axially extending abutment 129. Each tab 126 is connected with either a torque pad 140 or the backing plate disc 190 (FIG. 1 illustrates the tab 126 connected by a pin 130 to the torque pad 140; FIG. 2 illustrates another tab 126 connected by a pin 160 to the backing plate disc 190).

In FIG. 1, the torque pad 140 includes a wall 142 having a through axial opening 144 with a beveled seat 146. The abutment 129 of the tab 126 abuts the wall 142 of the torque pad 140. The pin 130 has a flanged head 132 and a through opening 134 to receive a cotter pin 150. Each pin 130 is received in a through opening 144 such that the flanged head 132 abuts the beveled seat 146. The pin 130 is also received in the through opening 128 of an aligned radially extending tang 127. The pin 130 is secured in place by the cotter pin 150 located in the through opening 134 of the pin 130. The torque pads 140 are secured axially to the tabs 126 of the backing plate 124 by the pins 130 and cotter pins 150. The carbon brake 100 has thirteen pins 130 and thirteen cotter pins 150 to secure thirteen torque pads 140 to thirteen tabs 126.

Referring again to FIG. 1, the backing plate disc 190 includes a plurality or circumferentially spaced-apart openings 192. Each opening 192 receives a torque pad 140. The torque pads 140 connect nonrotatably the backing plate disc 190 to the backing plate 124 of the carbon brake 100.

FIG. 2 is a partial cut-away illustration of the known aircraft carbon brake 100 of FIG. 1 at a different circumferential position of the torque tube 120. The same structure illustrated in both FIGS. 1 and 2 is identified by the same reference numeral. The carbon-carbon composite backing plate disc 190 includes a plurality of spaced-apart through openings 194 each having a beveled seat 196. A pin 160 having a beveled head 162 and a through opening 164 is received in each through opening 194 so that the beveled head 162 engages the beveled seat 196. The pin 160 extends through the through opening 128 of an aligned tang 127 and a cotter pin 170 is located in the through opening 164. The pin 160 and the cotter pin 170 secure axially the backing plate disc 190 to the backing plate 124.

It is advantageous to increase the service life of the carbon-carbon composite brake discs (e.g., increase the service runs during which the brake discs can be utilized) of a carbon brake, and/or to reduce the weight of the carbon brake, to thereby reduce the overall cost of utilizing carbon brakes in an aircraft. Therefore, it is highly desirable both to increase the amount of wearable friction material of the carbon-carbon composite brake discs in the carbon brake and to reduce the weight of the carbon brake.

The torque tube 120 of the known aircraft carbon brake 100 of FIGS. 1 and 2 has sixteen tangs 127, thirteen pins 130, three pins 160, thirteen cotter pins 150 and three cotter pins 170. It is advantageous for the apparatus connecting the backing plate disc 190 to the carbon brake 100 to require as few parts as necessary to reduce the overall weight of the apparatus and to minimize the number of parts. In some aircraft carbon brake applications, the radially extending tangs 127 are disposed close to the tie bolts (not shown) of the closely adjacent wheel (not shown), thereby requiring that the torque tube 120 in FIGS. 1 and 2 have an axial length short enough to ensure that the tangs 127, and the pins 130 and 160, do not engage the tie bolts.

Referring to FIGS. 1 and 2, it is desirable to increase the axial length of the torque tube 120 so that the axial thicknesses of the pressure plate disc (not shown), the stator discs (not shown), the rotor discs (not shown) and the backing plate disc 190 can be increased to maximize the mass or volume of the discs. If the mass of the discs is increased, then more friction material can be worn away during braking operations and the service life, commonly called the landings per overhaul (LPO), of the carbon brake 100 will be improved.

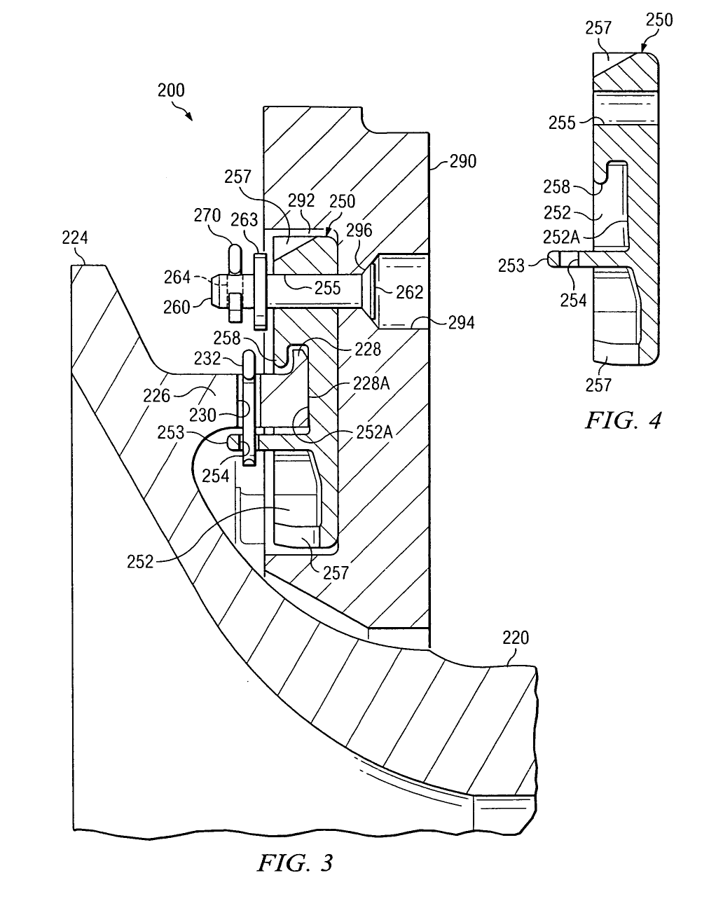

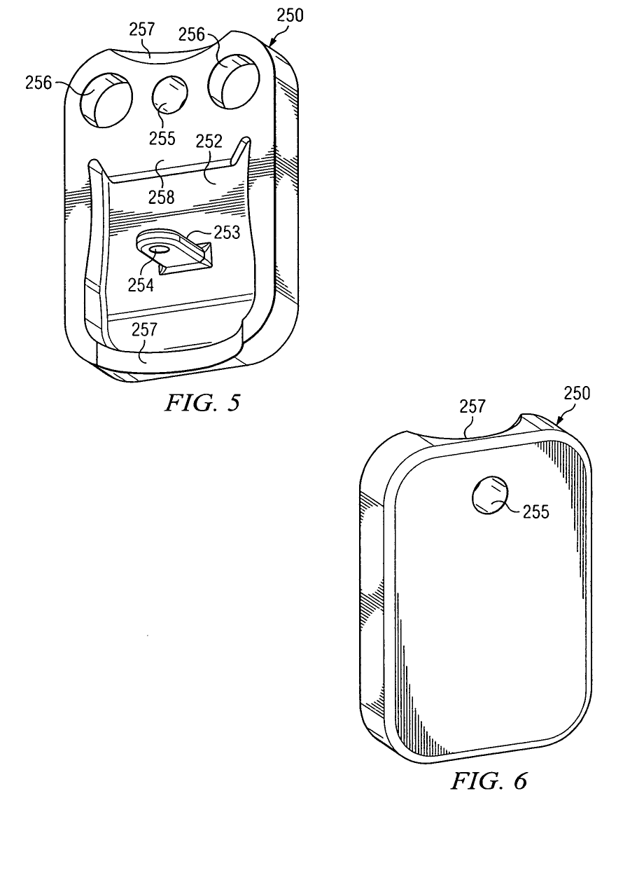

FIG. 3 is a partial cut-away illustration of an example carbon brake 200 showing the attachment of an example torque pad 250 to both the example carbon brake 200 and a carbon or carbon-carbon composite backing plate disc 290. Located about an example torque tube 220 is a plurality of interleaved stator and rotor discs (not shown) of which only the carbon composite backing plate disc 290 is shown. A backing plate 224 of the example torque tube 220 includes a plurality of circumferentially spaced-apart tabs 226. Each tab 226 includes a foot 228 having a foot end 228A and a through opening or receptacle 230. A connection member 232 such as, for example, a cotter pin, is located in the receptacle 230. Each foot end 228A engages an example torque pad 250 which is shown in greater detail in FIGS. 4-6. Each torque pad 250 has a through opening 255 and is received in a respective circumferentially spaced-apart and complementary-shaped opening 292 in the backing plate disc 290. The receipt of the torque pads 250 in the complementary-shaped openings 292 couples or connects the backing plate disc 290 nonrotatably to the example torque tube 220.

Referring to FIG. 3, the carbon composite backing plate disc 290 includes a selected number of circumferentially spaced-apart, through openings 294 each having a beveled seat 296. In the example carbon brake 200, the backing plate disc 290 has three through openings 294 each communicating with a respective opening 292. A pin 260 has a beveled head 262 and a through opening 264. Each pin 260 is received in a respective through opening 294 so that the beveled head 262 engages the beveled seat 296. As shown in FIG. 3, the pin 260 extends through the through opening 294 of the backing plate disc 290, the aligned through opening 255 of the example torque pad 250, and through a washer 263. The through opening 264 of the pin 260 receives a cotter pin 270 to secure the backing plate disc 290 to the example torque pad 250.

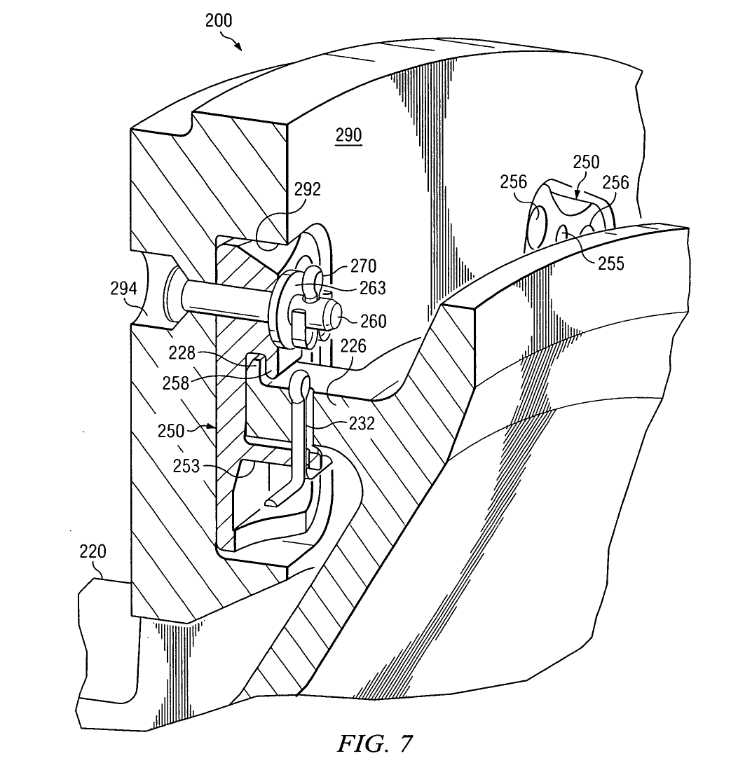

Referring now to FIGS. 3-6, the example torque pad 250 is generally rectangular-shaped and includes a first recess 252 with a surface 252A, and a tab member 253 is located in the first recess 252 and has a through passage or receptacle 254. Each example torque pad 250 has one or more second recesses 256 and cut-away perimeter areas 257, and an overhang 258 extending over the first recess 252. Referring to FIGS. 3, 7 & 8C, the foot 228 of the tab 226 is received in the first recess 252 and extends under the overhang 258 to couple axially the example torque pad 250 to the example torque tube 220. As shown in FIGS. 3 and 7, when the foot 228 is positioned under the overhang 258, the receptacle 254 of the tab member 253 is aligned with the receptacle 230 of the tab 226. The connection member 232 extends through the receptacles 230 and 254 to secure further the example torque pad 250 to the torque tube 220. Thus, the backing plate disc 290 is secured axially to the torque tube 220 by: (a) the pin 260 which attaches the backing plate disc 290 to the example torque pad 250, and (b) the foot 228 of the tab 226 which engages the overhang 258 of the example torque pad 250 to couple the example torque pad 250 to the example torque tube 220.

Referring to the known carbon brake shown in FIGS. 1 and 2, the torque tube 120 includes a group of thirteen radially extending tangs 127 each of which receives a pin 130 to attach the torque pad 140 to the torque tube 120 (see FIG. 1), and a separate group of three tangs 127 which receive the pins 160 to attach the backing plate disc 190 to the torque tube 120 (see FIG. 2).

FIG. 7 is a partial cut-away perspective illustration of the example carbon brake 200 showing the attachment of the example torque pad 250 to the example torque tube 220 and to the carbon composite backing plate disc 290. As disclosed above, the carbon composite backing plate disc 290 includes three circumferentially spaced-apart, through openings 294 each of which receives a pin 260 having a cotter pin 270 to attach an aligned example torque pad 250 to the backing plate disc 290. The example carbon brake 200 uses only a group of three pins 260 to attach the backing plate disc 290 to the example torque tube 220, and does not have a separate group of pins to attach the example torque pad 250 to the example torque tube 220 (see FIG. 7 wherein the example torque pad 250 located to the right side of the illustration does not have a pin 260, washer 263, and cotter pin 270). Thus, sixteen tangs and thirteen pins, such as the tangs 127 in FIGS. 1 and 2 and the pins 130 in FIG. 1, are eliminated to accomplish a reduction in parts and a weight savings for the carbon brake 200.

Referring again to FIGS. 1 and 2, in some aircraft carbon brake applications the radially extending tangs 127 are located close to the tie bolts (not shown) of the closely adjacent wheel (not shown), requiring that the torque tube 120 have an axial length short enough to ensure that the tangs 127, and the pins 130 and 160, do not engage the tie bolts. However, the example carbon brake 200 illustrated in FIGS. 3 and 7 does not include any tangs, such as the tangs 127 in FIGS. 1 and 2. Thus, the example carbon brake 200 includes an axially longer example torque tube 220 which may enable the pressure plate disc (not shown), the backing plate disc 290, and/or the carbon stator and rotor discs (not shown) to have larger axial thicknesses to maximize the mass or volume of the discs. By increasing the mass of the brake discs, more friction material can be worn away during braking operations and the LPO of the carbon brake can be improved.

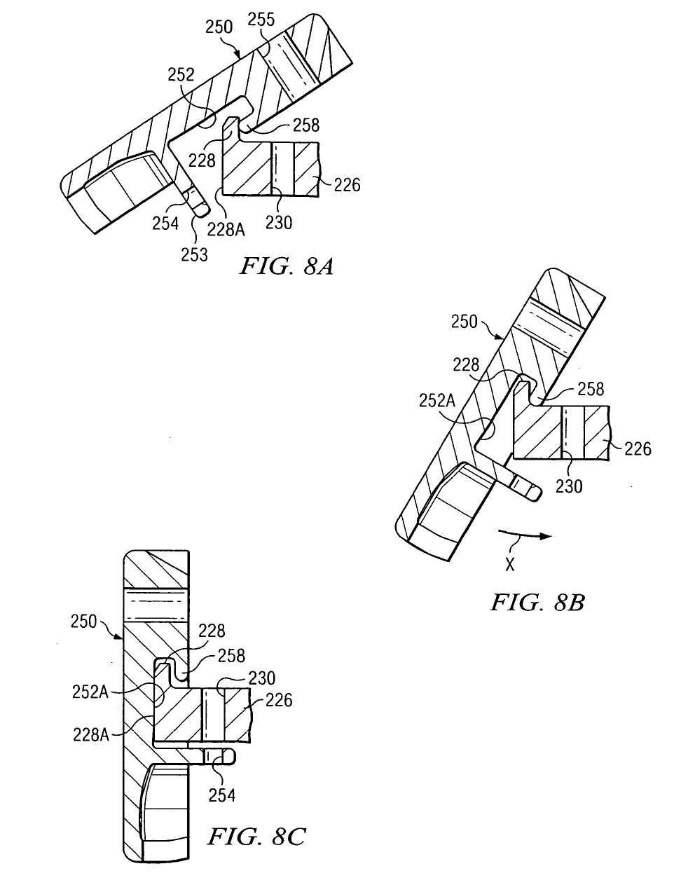

FIGS. 8A-C are schematic illustrations of the mounting of the example torque pad 250 to the example carbon brake 200. In FIG. 8A, the example torque pad 250 is positioned at an angle relative to the foot 228 and the tab 226 of the example torque tube 220 (the example torque tube 220 not shown in FIG. 8A) so that the foot 228 is introduced into and received by the first recess 252 of the example torque pad 250. Then in FIG. 8B the example torque pad 250 is rotated in the direction of arrow X so that the foot 228 is received under the overhang 258 of the example torque pad 250. As shown in FIG. 8C, when the example torque pad 250 has been rotated so that the foot 228 is fully received under the overhang 258 whereby the foot end 228A engages or abuts the surface 252A of the first recess 252, the example torque pad 250 is coupled axially to the tab 226 of the example torque tube 220. Also, the receptacle 230 of the tab 226 and the receptacle 254 of the example torque pad 250 are aligned (see FIG. 8C), and the connection member 232 is then inserted to secure further the example torque pad 250 to the example torque tube 220 (see FIG. 3).

Although the carbon or carbon composite backing plate disc 290 is described herein as a carbon-carbon composite brake disc, a carbon or carbon composite backing plate disc may include other types of carbon composite brake discs such as, for example, a carbon fiber/ceramic matrix composite brake disc, or a carbon-ceramic fiber/ceramic matrix composite brake disc. A carbon or carbon composite brake disc includes composites such as the other types of example composites.

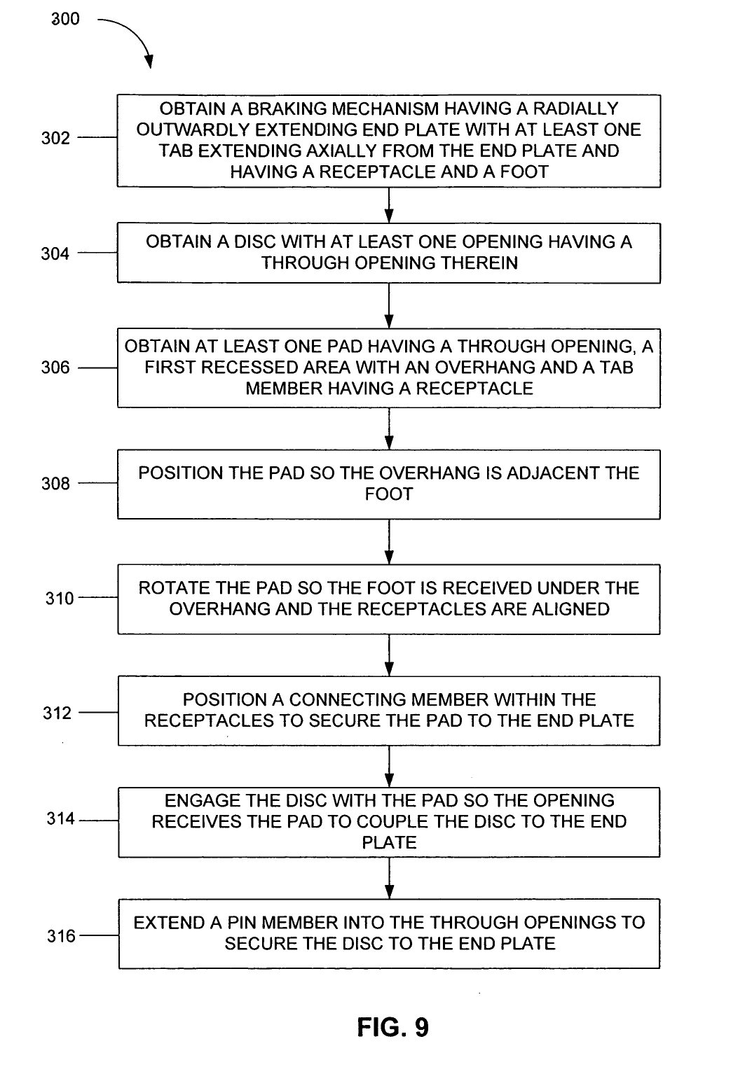

FIG. 9 is a flow diagram representative of an example method 300 to couple the backing plate disc 290 to the backing plate 224 of the example carbon brake 200. Initially, a braking mechanism (e.g., the carbon brake 200 in FIGS. 1 and 7) having a radially outwardly extending end plate (e.g., the backing plate 224 of the example torque tube 220 in FIGS. 3 and 7) with at least one tab extending axially from the end plate and having a receptacle and a foot (e.g., the tab 226 extending from the backing plate 224 and having a receptacle 230 and a foot 228, FIGS. 3, 7 and 8A-C), are obtained (block 302). At block 304, a disc (e.g., the backing plate disc 290 in FIGS. 3 and 7) with at least one opening having a through opening therein (e.g., in FIGS. 3 and 7, the opening 292 with the through opening 294), is obtained. Next at block 306, at least one pad (e.g., the example torque pad 250 in FIGS. 3-8) having a through opening (e.g., the through opening 255 in FIGS. 3-8), a first recessed area with an overhang (e.g., the first recess 252 with an overhang 258 in FIGS. 3-5 and 7-8) and a tab member having a receptacle (e.g., the tab member 253 having a receptacle 254 in FIGS. 3-8), are obtained. The pad is then positioned so that the overhang is adjacent the foot (e.g., the example torque pad 250 is positioned so the overhang 258 is adjacent the foot 228 of the tab 226 in FIG. 8A), block 308. The pad is rotated so the foot is received under the overhang (e.g., the example torque pad 250 is rotated in the direction of arrow X in FIG. 8B so that the foot 228 is received under the overhang 258, FIG. 8C), (block 310). At block 312, a connection member is positioned within the receptacles (e.g., the connection member 232 is positioned within the receptacle 230 of the tab 226 and the receptacle 254 of the tab member 253, FIGS. 3 and 7) to secure the pad to the end plate (e.g., the connection member 232 secures the example torque pad 250 to the backing plate 224, FIGS. 3 and 7). The disc is then engaged with the pad (e.g., the backing plate disc 290 engages the example torque pad 250, FIGS. 3 and 7) so that the opening in the disc receives the pad to couple the disc to the end plate (e.g., the opening 292 of the backing plate disc 290 receives the example torque pad 250 to couple the backing plate disc 290 to the backing plate 224), (block 314). And at block 316, a pin member (e.g., the pin member 260 in FIGS. 3 and 7) is extended into the through openings (e.g., the through opening 255 of the example torque pad 250 and the through opening 294 of the backing plate disc 290 that receive the pin member 260 in FIGS. 3 and 7) to secure the disc to the end plate (e.g., the pin member 260 secures the backing plate disc 290 to the backing plate 224, FIGS. 3 and 7).

An example method and apparatus are described with reference to the flowchart illustrated in FIG. 9. However, persons of ordinary skill in the art will readily appreciate that other methods of implementing the example method may alternatively be used. For example, the order of execution of the blocks may be changed, and/or some of the blocks described may be changed, eliminated, or combined.

Although certain example methods and apparatus have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A braking mechanism, comprising a radially outwardly extending end plate having circumferentially spaced-apart tabs extending axially from the end plate and each tab having a radially extending foot, a disc having circumferentially spaced-apart openings therein, and a plurality of pads each having an overhang and received in a respective spaced-apart opening of the disc, each foot extending within the respective overhang to couple non-rotatably the pad to the end plate.

2. A braking mechanism as defined in claim 1, wherein the foot extends radially outwardly.

3. A braking mechanism as defined in claim 1, wherein each pad has a first recessed area containing therein a tab member having a receptacle.

4. A braking mechanism as defined in claim 3, wherein the tabs of the end plate each have a receptacle, and further including a connection member received by each receptacle of the end plate and a respective tab member to secure the pad to the end plate.

5. A friction mechanism defined in claim 4, wherein the receptacles are through openings.

6. A braking mechanism as defined in claim 4, wherein the connection member is a cotter pin.

7. A braking mechanism as defined in claim 3, wherein the pad is generally rectangular shaped and includes at least one cut-away perimeter area and at least a second recessed area.

8. A braking mechanism as defined in claim 1, wherein at least one spaced-apart opening includes a through opening and the respective pad includes a through opening, and further including a pin member extending through the through openings to secure the disc to the end plate.

9. A braking mechanism as defined in claim 8, wherein the pin member has at one end an enlarged head to engage a periphery of the through opening in the disc and at an opposite end a securing mechanism to engage the pad.

10. A braking mechanism as defined in claim 1, wherein the braking mechanism is a wheel brake having stationary and rotational discs and includes a central member having splines received in slots of certain ones of the stationary discs, and further including a wheel having splines received in slots in the rotational discs.

11. A braking mechanism as defined in claim 10, wherein the stationary and rotational discs are carbon composite discs.

12. A braking mechanism as defined in claim 1, wherein the disc is an integral carbon composite backing plate disc.

13. A method to couple a disc with an end plate of a braking mechanism, the end plate extending radially outwardly with at least one tab extending axially from the end plate and including a foot, comprising:
providing the disc with at least one opening therein;
providing at least one pad having an overhang;
positioning the pad so the overhang is adjacent the foot;
rotating the pad so that the foot is received under the overhang; and
engaging the end plate with the pad so that the opening receives the pad to couple the disc to the end plate.

14. A method as defined in claim 13, wherein the pad includes a first recessed area containing therein a tab member having a receptacle.

15. A method as defined in claim 14, wherein the tab includes a receptacle, and the rotating aligns the receptacles.

16. A method as defined in claim 15, further including positioning a connecting member within the receptacles to secure the pad to the end plate.

17. A method as defined in claim 16, where the connecting member includes two legs that extend through the receptacles and diverge away from one another.

18. A method as defined in claim 13, wherein the at least one opening includes a through opening and the pad includes a through opening, and further including extending a pin member into the through openings to secure the disc to the end plate.

19. A method as defined in claim 13, wherein the disc is a carbon composite disc.

20. A method as defined in claim 13, wherein the disc is a backing plate disc and the braking mechanism includes stationary and rotational discs.
